(19) United States
(12) Patent Application Publication
(10) Pub. No.: US 2011/0192915 A1
(43) Pub. Date: Aug. 11, 2011

(54) SHOWER WITH JOYSTICK FUNCTION

(75) Inventors: Renzhong Li, Xiamen (CN); Zhongcheng Jin, Xiamen (CN); Jianmin Chen, Xiamen (CN); Huasong Zhou, Xiamen (CN)

(73) Assignees: XIAMEN SOLEX HIGH-TECH INDUSTRIES CO., LTD., Xiamen (CN); Huasong ZHOU, Xiamen (CN)

(21) Appl. No.: 12/701,978

(22) Filed: Feb. 8, 2010

(51) Int. Cl. B05B 1/16

(52) U.S. Cl. 239/394

(57) ABSTRACT

A shower with joystick function, comprising a fixed unit, a switching unit, and a watering unit, wherein the fixed unit comprises a main body and a supporting cover mounted together, a watering chamber able communicate to with the water supply. The center of said supporting cover has an upwardly projecting part and multiple sets of water outlets. The switching unit comprises a driving plate disposed in the watering chamber and rotably connected to the projecting part. The driving plate is connected to multiple sets of sealing columns uniformly and circumferentially spaced and respectively corresponding to each water outlet. A joystick projects from the driving plate, through the main body. The sealing columns are inserted or pulled out of the water outlets to seal or to open the water outlets by rotating the joystick. The watering unit is mounted under the fixed unit and comprises multiple watering sets.

### FIELD OF THE INVENTION

The present invention relates to a bath device, especially to a shower with joystick function which can achieve switchable multiple watering functions by rotating the joystick.

### BACKGROUND OF THE INVENTION

The switching shower of the present market are mainly two types, one is switched by a knob, another one is switched by rotating. The first kind has shortages as below: it can only applied in the switching between two functions, and can not be switched in multiple watering functions, such as three or four watering functions. The second kind of shower would take a large space; inconvenient to switch; moreover, the rotating surface is disposed on the outside, so it would require a high standard sealing effect.

### SUMMARY OF THE INVENTION

The present invention provides a shower with joystick function, it overcomes the shortages of the switching shower of the background technique.

The technical solution applied by the present invention is:

A shower with joystick function, it comprises:

A fixed unit, it comprises a main body and a supporting cover mounted together, a watering chamber which is able to communicate with the water supply formed between the main body and the supporting cover, the center of said supporting cover has an upwardly projecting part, said supporting cover is disposed with multiple sets of water outlets.

A switching unit, it comprises a driving plate disposed within watering chamber and rotably connected to said projecting part, said driving plate is connected to multiple sets of sealing columns which are uniformly and circumferentially spaced and respectively corresponding to each water outlet, a joystick is projecting disposed on said driving plate, said joystick goes through the main body from inside to outside for controlling, the sealing columns are controlled to insert into the water outlets for sealing or be pulled out to open the water outlet by rotating the joystick; and

A watering unit, it mounted under the fixed unit and comprises multiple watering sets which respectively communicate with the water outlets.

In a preferred embodiment: said switching unit further comprises a water division cover which is mounted under the supporting cover and disposed with multiple sets of water division holes which respectively communicate with the water outlets and watering sets.

In a preferred embodiment: said driving plate is disposed with a plurality of connection seats which are uniformly and circumferentially spaced, an opening slot is disposed on said connection seats; said sealing column comprises a rod, the outer rotating surface of said rod is fixed with a fixing plate and a sealing which are spaced up and down, said rod is connected inside the opening slot, said fixing plate and sealing clip the connection seat.

In a preferred embodiment: the bottom end of said rod is fixed with an intersectional plate unit, whose external diameter is adapted to the internal diameter of the water outlet.

In a preferred embodiment: a plurality of orientation slots are concave disposed under said main body, the top end of said rod is adapted to and slidably connected to the orientation slot.

In a preferred embodiment: the top end of said projecting part is disposed with a ball, the center of the bottom surface of said driving plate is concave disposed with a rotational slot, said rotational slot is adapted to the ball and connected together.

In a preferred embodiment: said fixed unit further comprises a handle which is fixed to the main body, said handle is hollow and communicates with the watering chamber and water supply.

In a preferred embodiment: said main body is disposed with a through step hole with a big bottom and a small top, said joystick stretches out of the step hole from inside to outside and a sealing ring is disposed between said step hole and joystick.

Compared to the background technique, the present invention applies the water division cover to cooperate with the driving plate for switching, thereby it can overcome the shortages of the background technique and it has such advantages: 1. the user only needs to rotate the joystick for switching, thereby it is convenient to switch; 2. because only the joystick is disposed outside of the shower, so it has a tidy appearance; 3. because only the joystick is disposed outside of the shower, so it only needs to seal the joystick and the shower to achieve a complete sealing effect, the sealing area will be small and the sealing requirement won't be too rigorous; 4. the switching structure is simple. The intersectional plate unit is not only used to open the water flow but also cooperate with the water outlet for orientating. The orientation slot slidably connected and adapted to the top end of the rod, so it can used for orientation. The rod is connected inside the opening slot, said fixing plate and sealing clip the connection seat, so the driving plate can be ensured to drive the sealing column to move up and down for precisely sealing or communicating. Because the driving plate and projecting part are connected by a ball, so it can be rotated omnidirectionally. Because a sealing ring is disposed between the step hole and rod, so the sealing effect is reliable, further the sealing ring has certain elasticity for providing certain space for the motion of the rod.

### BRIEF DESCRIPTION OF THE DRAWINGS

The present invention will become apparent upon the reference of the accompanying drawings and the description of the preferred embodiment.

FIG. 1 is the perspective exploded view of the shower with joystick function of a preferred embodiment.

FIG. 2 is the top view of the shower with joystick function of a preferred embodiment.

FIG. 3 is the sectional view of A-A line of FIG. 2, wherein said shower with joystick function flows flower watering.

FIG. 4 is the sectional view of B-B line of FIG. 2, wherein said shower with joystick function flows bubble water.

FIG. 5 is the sectional view of B-B line of FIG. 2, wherein said shower with joystick function flows massage watering.

### DETAILED DESCRIPTION OF THE EMBODIMENTS

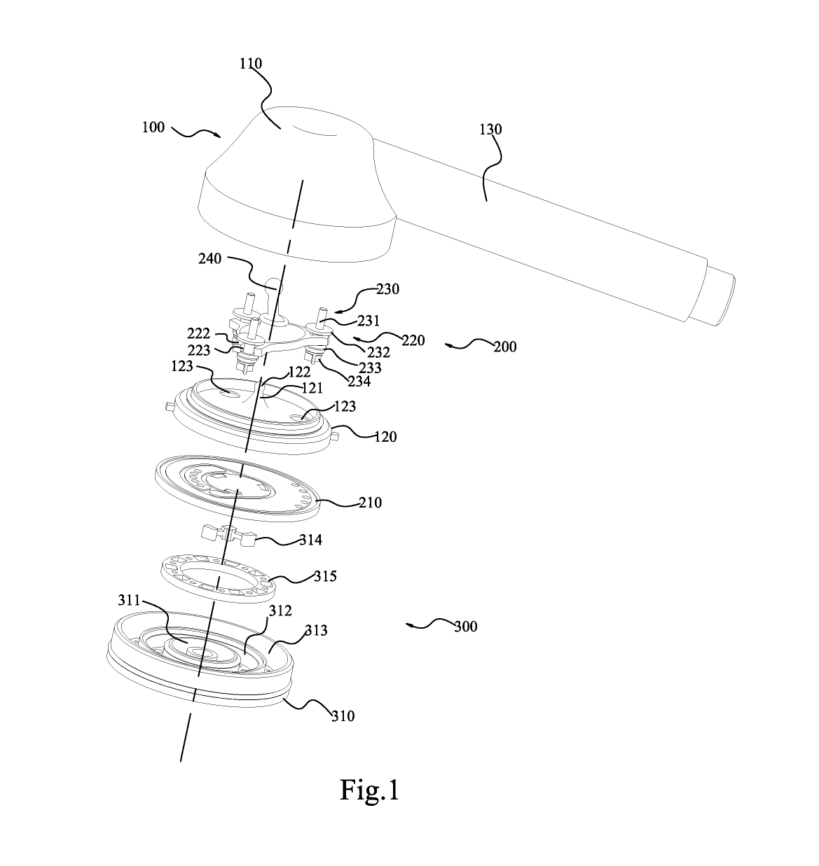

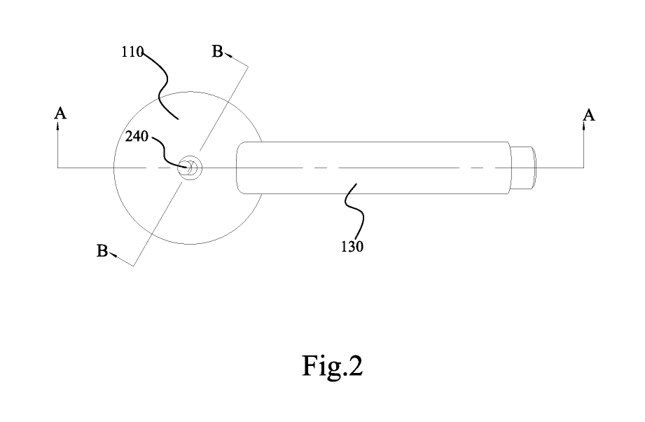

Please refer to FIG. 1 to FIG. 5, which shows the shower with joystick function of the present invention. The shower with joystick function, comprising a fixed unit 100\ a switching unit 200 and a watering unit 300.

Said fixed unit 100, it comprises a main body 110\ a supporting cover 120 and a handle 130. The bottom surface of said main body 110 in concave disposed with a concave chamber, said handle 130 is hollow and forms a water inlet channel (which can communicate with the water supply), said water inlet channel communicates with the concave chamber, in the present embodiment, said main body 110 and handle 130 is integrated in one body. Said supporting cover 120 is mounted under the main body 110, because of the concave chamber, so a watering chamber 111 which is able to communicate with the water inlet channel would be formed between the supporting cover and main body. The center of the top of said main body 110 is disposed with a through step hole 112 which has a big bottom and small top, said main body 110 further disposed with three uniformly and circumferentially spaced orientation slots 113. The center of said supporting cover 120 is disposed with a projecting part 121, whose top end has a ball 122. Said supporting cover has three water outlet holes 123, which are uniformly and circumferentially spaced.

Said switching structure 200, it comprises a water division cover 210\ a driving plate 220 and three sealing columns 230. Said water division cover 210 is mounted under the supporting cover 120 and has three sets of water division holes, said three sets of water division holes are respectively corresponding to the three water outlets hole 123. The center of the bottom surface of said driving plate 220 has a rotational slot 221, said rotational slot 221 is adapted and connected to the ball 122 of the projecting part 121 of supporting cover 120, so said driving plate 220 is rotatably disposed within the watering chamber 111. The center of the top surface of said driving plate 220 is projecting disposed with a joystick 240, which stretches out of the step hole 112 of main body 110 from inside to outside, a sealing ring 241 is disposed between the big hole of said step 112 and joystick 240. Said driving plate 220 has three connection seats 222 uniformly and circumferentially disposed, there is an opening slot 223 disposed on said connection seat 222. Said sealing column 230 comprises a rod 231, whose outer rotating surface of said rod 231 is fixed with a fixing plate 232 and a sealing 233 spaced up and down, said sealing 233 can comprise a sealing seat which fixed on the outer rotating surface of rod 231 and a sealing ring disposed inside the sealing seat. Said rod 231 is connected inside the opening slot 233, said fixing plate 232 and sealing 233 clip the connection seat 222; the bottom end of said rod 231 is fixed with an intersectional plate unit 234, the outer diameter of said intersectional plate unit is adapted to the inner diameter of water inlet, said intersectional plate unit 234 comprises a plurality of vertical and intersectional fixed plates whose intersecting surface looks like *shape or cross shape. The top end of rod 231 of said sealing column 230 is slidably connected to the orientation slot 113 of main body, its intersectional plate unit 234 is connected to the water outlet 123.

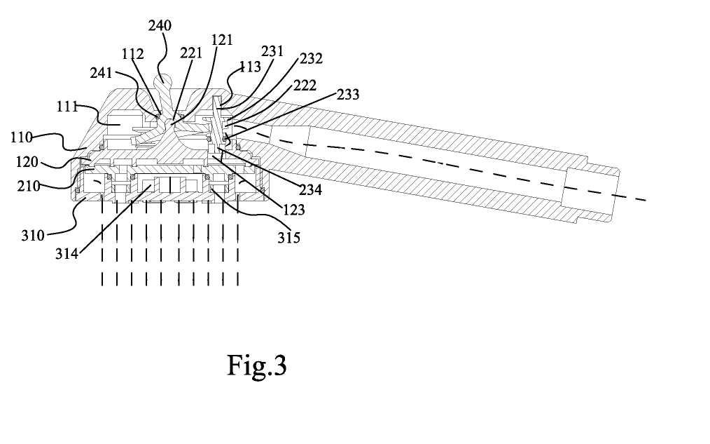

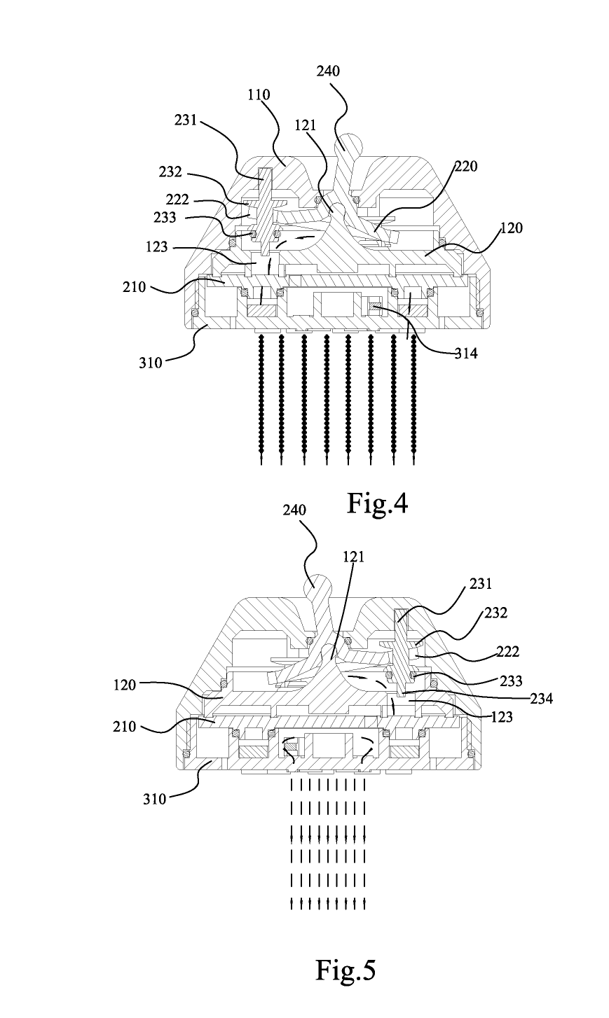

Said watering unit 300, which mounted on the fixed unit 100 and located under the water division cover 210, it comprises three sets of watering sets which respectively communicate with the water division hole. The present embodiment takes watering functions of the flower watering\ bubble water and massage watering as example, as showed in FIG. 3\ FIG. 4 and FIG. 5. Said watering unit 300 comprises a cover 310, three circumferential walls with the same axis are projecting disposed on said cover 310, thus three independent chambers 311\312\313 are formed by said three circumferential walls; a rotor 314 is disposed in the independent chamber 311 which is disposed innermost to generate the massage watering; a bubble gasket 315 is disposed in the middle dependent chamber 312 to generate the bubble water; the flower watering is generated by the outermost dependent chamber 313.

The switching method of the shower with joystick function of the present invention is: the user rotates the joystick 240, the driving plate 220 would rotate relative to the projecting part 121, and drives the sealing column 230 which is contrary to said move direction to move upwardly to open the corresponding water outlet holes, and to correspond the watering set; during the rotating process of the driving plate 220, another sealing column 230 would simultaneously be inserted downwardly to seal the corresponding water outlet; thereby the rotation switching is fulfilled.

The present embodiment take the above three watering functions as example, but it is not limited within, more watering functions as four or five are also suitable in the present invention.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What the claim is:

1. A shower with joystick function is characterized in that: it comprises:
a fixed unit, it comprises a main body and a supporting cover mounted together, a watering chamber which is able to communicate with the water supply formed between the main body and the supporting cover, the center of said supporting cover has an upwardly projecting part, said supporting cover is disposed with multiple sets of water outlets.
a switching unit, it comprises a driving plate disposed within watering chamber and rotably connected to said projecting part, said driving plate is connected to multiple sets of sealing columns which are uniformly and circumferentially spaced and respectively corresponding to each water outlet, a joystick is projecting disposed on said driving plate, said joystick goes through the main body from inside to outside for controlling, the sealing columns are controlled to insert into the water outlets for sealing or be pulled out to open the water outlet by rotating the joystick; and
a watering unit, it mounted under the fixed unit and comprises multiple watering sets which respectively communicate with the water outlets.

2. The shower with joystick function according to claim 1 is characterized in that: said switching unit further comprises a water division cover which is mounted under the supporting cover and disposed with multiple sets of water division holes which respectively communicate with the water outlets and watering sets.

3. The shower with joystick function according to claim 1 is characterized in that: said driving plate is disposed with a plurality of connection seats which are uniformly and circumferentially spaced, an opening slot is disposed on said connection seats; said sealing column comprises a rod, the outer rotating surface of said rod is fixed with a fixing plate and a sealing which are spaced up and down, said rod is connected inside the opening slot, said fixing plate and sealing clip the connection seat.

4. The shower with joystick function according to claim 3 is characterized in that: the bottom end of said rod is fixed with an intersectional plate unit, whose external diameter is adapted to the internal diameter of the water outlet.

5. The shower with joystick function according to claim 3 is characterized in that: a plurality of orientation slots are concave disposed under said main body, the top end of said rod is adapted to and slidably connected to the orientation slot.

6. The shower with joystick function according to claim 1 is characterized in that: the top end of said projecting part is disposed with a ball, the center of the bottom surface of said driving plate is concave disposed with a rotational slot, said rotational slot is adapted to the ball and connected together.

7. The shower with joystick function according to claim 1 is characterized in that: said fixed unit further comprises a handle which is fixed to the main body, said handle is hollow and communicates with the watering chamber and water supply.

8. The shower with joystick function according to claim 1 is characterized in that: said main body is disposed with a through step hole with a big bottom and a small top, said joystick stretches out of the step hole from inside to outside and a sealing ring is disposed between said step hole and joystick.

9. The shower with joystick function according to claim 2 is characterized in that: said driving plate is disposed with a plurality of connection seats which are uniformly and circumferentially spaced, an opening slot is disposed on said connection seats; said sealing column comprises a rod, the outer rotating surface of said rod is fixed with a fixing plate and a sealing which are spaced up and down, said rod is connected inside the opening slot, said fixing plate and sealing clip the connection seat.

10. The shower with joystick function according to claim 9 is characterized in that: the bottom end of said rod is fixed with an intersectional plate unit, whose external diameter is adapted to the internal diameter of the water outlet.

11. The shower with joystick function according to claim 9 is characterized in that: a plurality of orientation slots are concave disposed under said main body, the top end of said rod is adapted to and slidably connected to the orientation slot.

12. The shower with joystick function according to claim 2 is characterized in that: the top end of said projecting part is disposed with a ball, the center of the bottom surface of said driving plate is concave disposed with a rotational slot, said rotational slot is adapted to the ball and connected together.

13. The shower with joystick function according to claim 2 is characterized in that: said fixed unit further comprises a handle which is fixed to the main body, said handle is hollow and communicates with the watering chamber and water supply.

14. The shower with joystick function according to claim 2 is characterized in that: said main body is disposed with a through step hole with a big bottom and a small top, said joystick stretches out of the step hole from inside to outside and a sealing ring is disposed between said step hole and joystick.
